(19) United States
(12) Patent Application Publication
(10) Pub. No.: US 2021/0032507 A1
(43) Pub. Date: Feb. 4, 2021

(54) System and Method for Material Transfer

(71) Applicant: Jodi Schwendimann, Wayzata, MN (US)

(72) Inventors: Jodi Schwendimann, Wayzata, MN (US); Hemant Bohra, Minnetonka, MN (US)

(73) Assignee: Jodi Schwendimann, Wayzata, MN (US)

(21) Appl. No.: 16/529,097

(22) Filed: Aug. 1, 2019

(51) Int. Cl. C09J 7/40; C09J 133/02; C09J 133/10; C09J 131/04; C09J 5/06

(52) U.S. Cl. CPC C09J 7/401; C09J 133/02; C09J 133/10; C09J 2483/005; C09J 5/06; C09J 2400/28; C09J 131/04

(57) ABSTRACT

The present disclosure, in one embodiment, relates to a system and method to transfer material to a substrate. In one embodiment, the system for material transfer includes an adhesive sheet and a transfer material sheet. The adhesive sheet comprises an adhesive, such as ethylene acrylic acid (EAA), ethylene methacrylic acid (EMAA), or ethylene-vinyl acetate (EVA), and a paper release backing. The paper release backing may comprise supercalendered kraft base paper. The transfer material sheet may include a transfer material and a material release liner. The transfer material may be metallized polyester

### FIELD OF THE INVENTION

The present disclosure relates to a system and method for material transfer. More specifically, the present disclosure relates to a system and method for transferring material onto a substrate.

### BACKGROUND OF THE INVENTION

Expressing creativity can bring about feelings of great satisfaction and self-worth. A popular way of expressing oneself is to make custom t-shirts. Custom t-shirts may be made by designing iron-ons for the t-shirt. Materials for iron-on transfer to t-shirts or other substrates are disclosed in U.S. application Ser. No. 12/218,260, entitled METHOD OF IMAGE TRANSFER ON A COLORED BASE, issued as U.S. Pat. No. RE 41623; U.S. application Ser. No. 08/816,890, entitled HAND APPLICATION TO FABRIC OF HEAT TRANSFERS IMAGED WITH COLOR COPIERS/PRINTERS, issued as U.S. Pat. No. 5,948,586; and U.S. application Ser. No. 09/541,083, entitled POLYMERIC COMPOSITION AND PRINTER/COPIER TRANSFER SHEET CONTAINING THE COMPOSITION, issued as U.S. Pat. No. 6,410,200; herein incorporated by reference in their entirety. However, prior to the present invention, transfer of materials such as foils have required special machines and been cumbersome for consumer use. Also, some of the approaches in the past use materials that make the cost of manufacture more expensive.

Therefore, there is a need for a system and method for transferring material onto a substrate that is inexpensive and does not require special machines. Furthermore, there is a need for a product may be manufactured more cost effectively. One or more embodiments of the present invention addresses one or more of these needs.

### BRIEF SUMMARY OF THE INVENTION

The present disclosure, in one embodiment, relates to a device, system, and method for transferring material onto a substrate.

In one embodiment, the system for material transfer includes an adhesive sheet and a transfer material sheet. The adhesive sheet comprises an adhesive, such as ethylene acrylic acid (EAA), ethylene methacrylic acid (EMAA), or ethylene-vinyl acetate (EVA), and a paper release backing. The paper release backing may comprise supercalendered kraft base paper. The transfer material sheet may include a transfer material and a material release liner. The transfer material may be metallized polyester.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The present disclosure relates to a system and method for transferring material to a substrate. While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 illustrates a system for material transfer, in accordance with one embodiment.

FIG. 2a illustrates an adhesive sheet, in accordance with one embodiment.

FIG. 2b illustrates an adhesive sheet, in accordance with one embodiment.

FIG. 3 illustrates a transfer material sheet, in accordance with one embodiment.

FIG. 4 illustrates a parchment liner, in accordance to one embodiment.

FIG. 5 illustrates a material transfer kit, in accordance with one embodiment.

FIG. 6 illustrates a flow diagram of a method for transferring material to a substrate.

FIG. 7 illustrates a cut adhesive sheet comprising adhesive sheet with a cut design and non-design adhesive, in accordance with one embodiment.

FIG. 8 illustrates a cut adhesive sheet with the non-design adhesive removed, leaving only the cut design, in accordance with one embodiment.

FIG. 9 illustrates a substrate with the cut adhesive sheet placed thereon, in accordance with one embodiment.

FIG. 10 illustrates a finished product, in accordance with one embodiment.

FIG. 11 illustrates a cross-sectional view of the finished product, in accordance with one embodiment.

### DETAILED DESCRIPTION

The present disclosure relates to a system and method for transferring material to a substrate. In one embodiment, the present disclosure relates to a system and method for transferring foil material to a textile substrate, such as a t-shirt, using heat. In other embodiments, the substrate may be, for example, leather, ceramic, wool, glass, plastic, metal, paper, or canvas material.

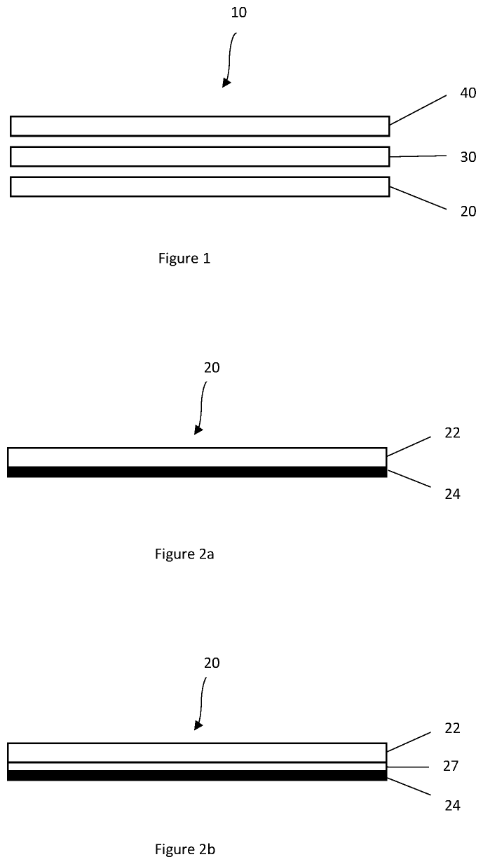

FIG. 1 illustrates a system 10 for material transfer, in accordance with one embodiment. The system may be used for transferring material to a substrate. As shown, the system 10 may comprise an adhesive sheet 20, a transfer material sheet 30, and a parchment liner 40. The material may be transferred to the substrate using heat.

FIG. 2a illustrates an adhesive sheet 20, in accordance with one embodiment. As shown, the adhesive sheet 20 may comprise an adhesive 22 on a release backing 24. Adhesive 22 may also be referred to as an adhesive layer or resin layer. The adhesive 22 may be a heat activated adhesive or thermal adhesive film.

FIG. 2b illustrates an adhesive sheet 20, in accordance with a further embodiment. As shown, the adhesive sheet 20 may comprise an adhesive 22 on a release backing 24. Adhesive 22 may also be referred to as an adhesive layer or resin layer. The adhesive 22 may be a heat activated adhesive or thermal adhesive film. In the embodiment of FIG. 2b, a release coating 23 is provided between the release backing 24 and the adhesive 22.

The adhesive 22 may be a compound that is suitable for attaching the material to the substrate. Compounds used for the adhesive can include, but are not limited to, an ethylene copolymer such as ethylene acrylic acid (EAA), ethylene methacrylic acid (EMAA), or ethylene-vinyl acetate (EVA). In some examples, the EAA or EMAA includes a melt index from about 5 to about 2500, such as from about 10 to about 1300. In some examples, the EAA or EMAA includes an acrylic acid concentration from about 0% to about 30%, such as from about 1% to about 20% for emulsion purposes. In some examples, the EAA, EMAA or EVA includes a melt point temperature between about 43° Celsius to about 160° Celsius. In some examples, the adhesive layer comprises EVA with a vinyl acetate content of about 3% to about 45%. In some examples, an EVA resin or adhesive layer also includes a wax emulsion to provide better adhesion and flexibility to the transferred material. In some examples, an EVA resin or adhesive layer includes a carboxylic element to provide increased adhesion and toughness to the transferred material.

The thickness of the adhesive layer may be customized for specific applications. Specifically, the thickness of the adhesive layer may be adjusted such that the adhesive has a stronger or weaker grip depending on the requirements of the transfer material. If the adhesive is not sufficiently strong, the transfer material may not break for adhesion to the substrate.

The adhesive 22 is provided on a release backing 24. The release backing 24 may be a paper sheet. By using paper as the release backing 24, the cost of the adhesive sheet 20 is kept down. In one embodiment, the release backing may comprise a supercalendered kraft (SCK) base paper. An SCK base paper is a smooth, non-filler-added, transparent release base paper. In other embodiments, other types of release backing may be provided.

Paper does not have a natural release and thus an adhesive release liner 27 may be provided between the paper sheet and the adhesive. In some embodiments, the adhesive release liner 27 may be a silicone adhesive release liner such that the release backing 24 is a silicone coated base paper. The silicone adhesive release liner is selected to have high heat resistant properties. The silicone adhesive release liner may have a release value of about 10 to 2500 g/inch, using a Tesa Tape 7375 tmi, 90 degree angle, 1 inch tape, 12 inches per minute. The adhesive release liner may, in some embodiments, be impregnated with titanium oxide or other white pigments in a concentration of about 20% by weight. Other adhesive release liners such as fluorocarbon, urethane, or acrylic base polymer are may alternatively be used.

The adhesive release liner 27 acts as a release-enhancing layer. When heat is applied, local changes in temperature and fluidity of the adhesive, such as a low density polyethylene or other polymeric material, occur. Low density polyethylene, ethylene acrylic acid (EAA), or MEAA, ethylene vinyl acetate (EVA), polyester exhibit a melt point from 20° C. up to 225° C. These local changes are transmitted into the adhesive release liner 27 and result in local preferential release of the adhesive 22.

In one embodiment, the adhesive sheet 20 comprises ethylene acrylic acid (EAA), ethylene methacrylic acid (EMAA), or ethylene-vinyl acetate (EVA) coated on the top surface of a paper release backing 24 with a silicone adhesive release liner 27 provided therebetween.

Upon heating of the adhesive sheet 20, the adhesive 22 adheres to a substrate and the release backing 24 may be pulled from the adhesive, leaving the adhesive in place on the substrate.

The adhesive sheet 20 is configured such that it may be cut using any suitable cutting implement. For example, the adhesive sheet may be cut using a vinyl cutter, scissors, design punch, electronic cutting machine, or any other suitable cutting device. Because the adhesive 22 is not tacky when cold, the adhesive will not adhere to the cutting implement.

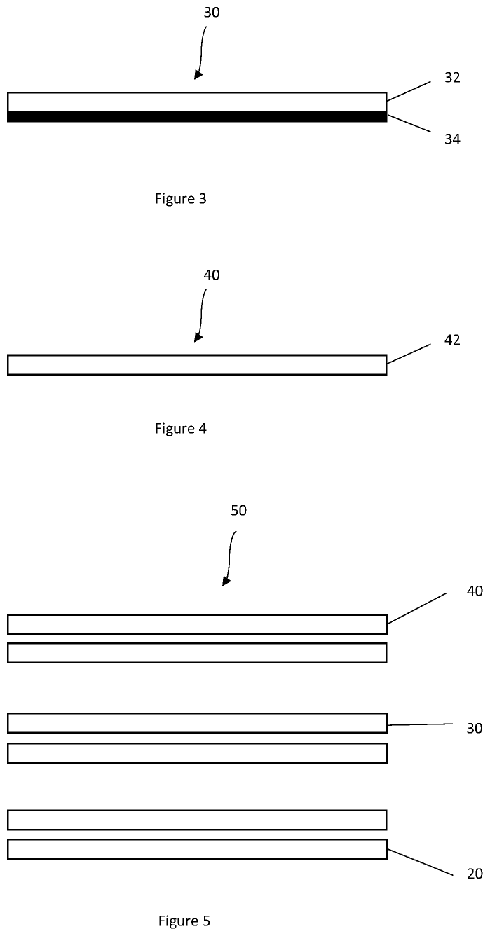

FIG. 3 illustrates a transfer material sheet 30, in accordance with one embodiment. As shown, the transfer material sheet 30 may comprise a transfer material layer 32 and a material release liner 34. The transfer material layer 32 may comprise any material that is desired to be transferred to the substrate and that is capable of sticking to the adhesive. In some embodiments, the transfer material sheet comprises a foil sheet transfer material layer 32 on a material release liner 34. In general, the transfer material may include foil, metallic flakes, metallic-like flakes, glitter materials, sparkle materials, luminescent materials (e.g. having a glow-in-the-dark effect), pearlescent materials, reflective materials, or combinations thereof so long as the material will adhere to the adhesive and release from the release liner.

The material release liner 34 may be any material that grips the transfer material but releases the transfer material relatively easily when the transfer material sticks to an adhesive. In one embodiment, a silicone liner is used as the release liner 34.

In the embodiment shown in FIG. 3, the transfer material may have a preferred side. For example, one side of the transfer material may be shinier than the other side. Whichever side is intended to be visible once the transfer material is transferred to the substrate is provided facing the release liner 34.

In one embodiment, the transfer material sheet is a foil transfer material sheet comprising a metallized polyester. The thickness of the metallized polyester is selected to permit heat to penetrate the metallized polyester. When heat is applied to the metallized polyester sheet (e.g., the foil) that is on the adhesive 22 that was applied to the substrate (e.g., the fabric or paper), the heat will cause the sticky resin or adhesive 22 on the substrate to get tacky and adheres to the metallized polyester and allows for the material release liner 34 to be removed. In some embodiments, the metallized polyester sheet ranges from 50-90 gauge in thickness.

In some embodiments, the transfer material sheet may not include a material release liner. In such embodiments, the portion of the transfer material sheet that does not stick to the adhesive tears from the portion of the transfer material sheet that does stick to the adhesive. Weeding may be done to remove material that is not on adhered to the adhesive.

FIG. 4 illustrates a parchment liner 40, in accordance to one embodiment. The parchment liner 40 comprises a parchment material 42. The parchment liner 40 protects the release material sheet from direct heat. The thickness of the parchment material 42 may be selected to permit heat to penetrate the parchment liner 40. One type of parchment paper that may be used is silicone parchment paper 25 lbs.

FIG. 5 illustrates a material transfer kit 50, in accordance with one embodiment. As shown, the material transfer kit may comprise two adhesive sheets 20, two transfer material sheets 30, and two parchment liners 40. In some embodiments, the two transfer material sheets may comprise two sheets of foil.

Transferring the Material

The material transfer system disclosed allows a user to transfer material to a substrate in a particular arrangement desirable to the user.

The substrate may be any desired substrate. The substrate may be a fabric textile such as a t-shirt, apron, gym bag, pillow case, jersey, etc. Alternatively, the substrate may be leather, ceramic, wool, glass, plastic, metal, canvas, paper, or other.

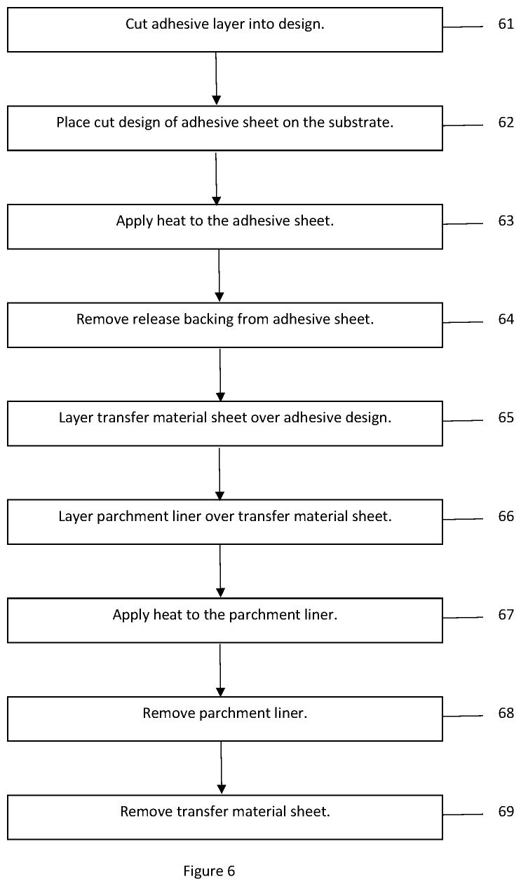

FIG. 6 illustrates a flow diagram of a method 60 for transferring material to a substrate. As shown, the adhesive layer of the adhesive sheet is cut into a design at step 61. The cut design of the adhesive sheet is placed on the substrate at step 62. Heat is applied to the adhesive sheet at step 63. The release backing is removed from the adhesive sheet at step 64. The transfer material sheet is layered over the adhesive design at step 65. The parchment liner is layered over transfer material sheet at step 66. Heat is applied to the parchment liner at step 67. The parchment liner is removed at step 68. The release liner is removed at step 69, leaving the transfer material in place on the substrate.

Each of the steps shown in FIG. 6 is discussed in more detail below.

The adhesive layer of the adhesive sheet may be cut into a design or desired configuration using any suitable cutting device. Such cutting may be done using a vinyl cutter, scissors, design punch, electronic cutting machine, or any other cutter. The cut design is a mirror image of the design that will be transferred to the substrate. In some embodiment, only the adhesive layer is cut. In other embodiments, cutting the adhesive layer may comprise cutting the adhesive sheet.

In some embodiments, it may be useful to increase the thickness of the adhesive by layering two adhesive layers. This may be done by cutting one adhesive layer in a mirror image of a design and another adhesive layer in the standard design. The two cut designs (mirror and standard) maybe be layered together with the backing removed from one of the sides for application to the substrate, as described with respect to a single adhesive layer below.

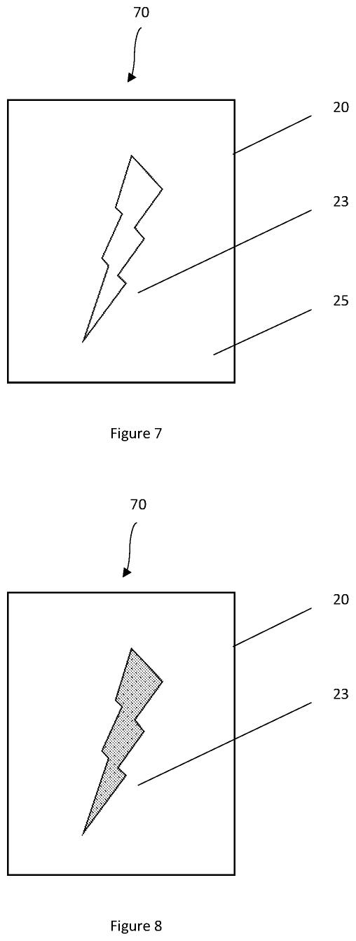

FIG. 7 illustrates a cut adhesive sheet 70 comprising adhesive sheet 20 with a cut design 23 and non-design adhesive 25, in accordance with one embodiment. If the adhesive sheet is done using a vinyl cutter, the vinyl cutter may be be set to the vinyl level such that the cutter cuts through the adhesive but not through the paper. The vinyl cutter design lab may be used to mirror the desired design before sending to the vinyl cutter. Using a vinyl cutter, after cutting the design, both the cut design 23 and the non-design adhesive 25 are present on the release backing.

FIG. 8 illustrates a cut adhesive sheet 70 with the non-design adhesive removed, leaving only the cut design 23, in accordance with one embodiment. This is done in a process called weeding wherein the non-design adhesive is removed from the release backing. FIG. 8 illustrates the cut design 23 positioned on top of the release backing.

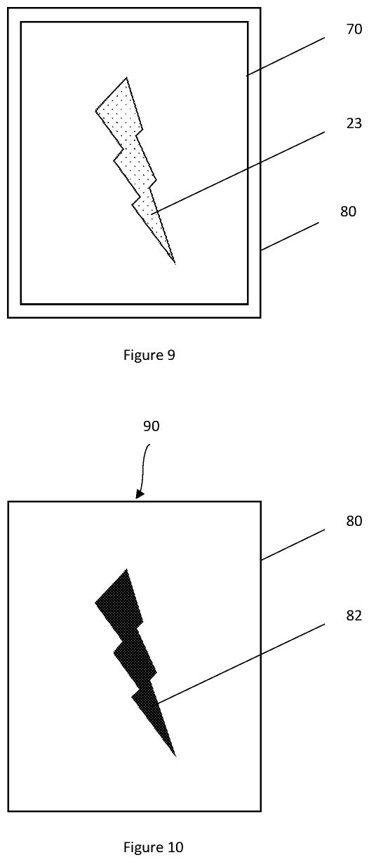

After cutting (and weeding if necessary), the cut design of the adhesive sheet is placed adhesive side down on the substrate. This positions the design in the orientation that the material will take after transfer. FIG. 9 illustrates a substrate 80 with the cut adhesive sheet 70 placed thereon. As shown, the cut adhesive sheet 70 is placed face down on the substrate 80 such that the cut design 23 is sandwiched between the substrate 80 and the release backing, in accordance with one embodiment. As shown, the cut design 23 is in a flipped orientation from the orientation shown in FIG. 8 (where the cut design 23 was shown on top of the release backing).

Heat is applied to the adhesive sheet. In some embodiments, heat is applied for 60 seconds. This may be done by a household iron, a heat press, or other heating utensil. Because the release backing is positioned over the adhesive, the heat is applied to the release liner and not directly to the adhesive. The release backing may be removed while the adhesive is warm or after the adhesive has cooled; preferably, the release backing is peeled after the adhesive has cooled. The adhesive design remains on the substrate material after the release backing is removed.

The transfer material sheet is layered over the adhesive design on the substrate. The transfer material sheet may be placed while the adhesive is hot or after the adhesive has cooled; preferably, the transfer material sheet is place after the adhesive has cooled. The transfer material layer is sandwiched between the adhesive design and the material release liner. As previously discussed, if a side of the transfer material is specifically desired to be displayed after transfer, that side is positioned against the material release liner such that that side is in an upward orientation when the transfer material sheet is placed over the adhesive design.

The parchment liner is layered over the transfer material. Heat is applied to the parchment liner. This may be done by a household iron, a heat press, or other heating utensil. The heat activates the adhesive and/or the transfer material and the transfer material is adhered to the adhesive.

The parchment liner is removed. The transfer material sheet is allowed to cool and the material release liner is removed. FIG. 10 illustrates a finished product 90 with the substrate 80 having a transfer material design 82 adhered thereto, in accordance with one embodiment.

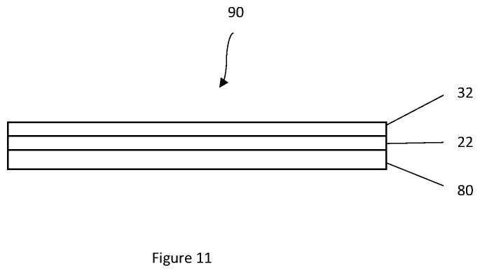

FIG. 11 illustrates a cross-sectional view of the finished product 90, in accordance with one embodiment. As shown, the substrate material is provided on the bottom. Adhesive 22 is provided over the substrate material 80 and the transfer material layer 32 is provided over the adhesive.

In one embodiment, for use light and dark fabrics, the following procedure may be used for fabric foil transfer:
1. Prewash fabric to reduce wrinkles (preferably do not use fabric softener) then lint roll fabric
2. Preheat iron to cotton settings
3. Cut the adhesive sheets included in foil kit to desired design.
   a. Compatible with scissors, die-cutter, stamp cut out Cricut™ Silhouette™ or similar cutting machine
   b. Mirror or flip the image before cutting on Cricut™ Silhouette™ or similar cutting machine
   c. When using Cricut™ have glossy side face up on mat using the vinyl cut settings
4. Once desired image is cut, place on fabric; glossy side on fabric and iron:
   a. 4×4 area iron for 30 seconds
   b. 8×8 area iron for 60 seconds
   c. Larger than 8″ iron for 80-90 seconds
5. After you iron the adhesive to fabric, let it cool. In some embodiments, it is important to not reapply heat.
6. Once adhesive is cool, peel off of fabric keeping the fabric on a flat surface. (Preferably, peel at a 90-degree angle).
7. Cut a piece of the foil to cover the desired transfer area.
8. Place the foil over the ironed adhesive—(in one embodiment, preferably cut an extra ¼ inch of foil on each side to ensure full coverage of the transfer.) In one embodiment, foil patterned side facing upwards, solid matte side on fabric.
9. Place a sheet of parchment paper on top of the foil and iron:
   a. 4″×4″ area iron for 20-30 seconds
   b. 8″×8″ area iron for 45 seconds
   c. Larger than 8 inches iron for 60 seconds
10. Remove parchment paper immediately after ironing
11. In one embodiment, wait until the foil is cool and peel at a sharp angle while on a flat surface.

In one embodiment, for use with paper, the following procedure may be used for paper foil transfer:
1. Preheat iron to highest setting
2. Cut the adhesive sheets included in foil kit to desired design.
   a. Compatible with scissors, die-cutter, stamp cut out Cricut™ Silhouette™ or similar cutting machine
   b. Mirror or flip the image before cutting on Cricut™ Silhouette™ or similar cutting machine
   c. When using Cricut™ have glossy side face up on mat using the vinyl cut settings
3. Once desired image is cut, place on paper/cardstock; glossy side on fabric and iron.
4. Iron for approximately 30-40 seconds.
5. After you iron the adhesive to paper/cardstock, let it cool. In some embodiments, it is important to not reapply heat.
6. Once adhesive is cool, peel off of paper/cardstock keeping the paper/cardstock on a flat surface. (Preferably, peel at a 90-degree angle).
7. Cut a piece of the foil to cover the desired transfer area.
8. Place the foil (included in kit) over the ironed adhesive—(in one embodiment, preferably cut an extra ¼ inch of foil on each side to ensure full coverage of the transfer.) In one embodiment, foil patterned side facing upwards, solid matte side on paper/cardstock.
9. Place a sheet of parchment paper (included in kit) on top of the foil and iron for approximately 35-40 seconds.
10. Remove parchment paper immediately after ironing
11. In one embodiment, wait until the foil is cool and peel at a sharp angle while on a flat surface.

In the foregoing description various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A system for material transfer, the system comprising:
an adhesive sheet comprising:
an adhesive;
an adhesive release liner;
a paper release backing; and
a transfer material sheet.

2. The system of claim 1, wherein the adhesive comprise one of ethylene acrylic acid (EAA), ethylene methacrylic acid (EMAA), or ethylene-vinyl acetate (EVA).

3. The system of claim 1, wherein the paper release backing comprises supercalendered kraft (SCK) base paper.

4. The system of claim 1, wherein the adhesive release liner is a silicone adhesive release liner.

5. The system of claim 1, wherein the adhesive release liner comprises fluorocarbon, urethane, or an acrylic base polymer.

6. The system of claim 1, wherein the transfer material sheet is a foil transfer material sheet.

7. The system of claim 6, wherein the foil transfer material sheet comprises a metallized polyester.

8. The system of claim 1, wherein the transfer material sheet comprises a transfer material layer and a material release liner.

9. The system of claim 1, further comprising a parchment liner.

10. A system for material transfer, the system comprising:
an adhesive sheet comprising:
an adhesive, the adhesive being one of adhesive comprise one of ethylene acrylic acid (EAA), ethylene methacrylic acid (EMAA), or ethylene-vinyl acetate (EVA);
a silicone adhesive release liner;
a paper release backing; and
a transfer material sheet, the transfer material sheet comprising:
a transfer material layer, the transfer material layer comprising metallized polyester; and
a material release liner.

11. A method for transferring foil onto a substrate, comprising:
cutting a design on adhesive sheet having an adhesive layer and a release backing;
placing the adhesive sheet on the substrate;
applying heat to the adhesive sheet;
removing release backing from the adhesive sheet;
placing foil having a release liner over the adhesive layer on the substrate;
applying heat indirectly to the foil;
removing the release liner.

12. The method of claim 11, further comprising the step of placing parchment paper over
